(19) United States
(12) Patent Application Publication
(10) Pub. No.: US 2003/0208403 A1
(43) Pub. Date: Nov. 6, 2003

(54) Merchant configurable loyalty system

(76) Inventors: David Landis Fisher, Tega Cay, SC (US); Michael S. McClain, Basking Ridge, NJ (US)

Correspondence Address: DAVID L. FISHER, CARDSMART TECHNOLOGIES INC., 1140 MOLOKAI DRIVE, TEGA CAY, SC, 29708, US

(21) Appl. No.: 10/419,301

(22) Filed: Apr. 22, 2003

Related U.S. Application Data
(60) Provisional application No. 60/375,991, filed on Apr. 29, 2002.

(51) Int. Cl. G06F 17/60

(52) U.S. Cl. 705/14

(57) ABSTRACT

With greater frequency, POS (point of sale) devices are being deployed for retail loyalty applications. The current process is for each of these applications to be custom programmed for each merchant. Such custom application development significantly increases the cost beyond the reach of small to midsize merchants. This invention is an “out-of-the-box”, turnkey retail marketing solution that empowers individual merchants to set up and configure their own customer loyalty applications using their own unique cards or tokens, or by enrolling compatible cards and/or tokens from other programs. Now smaller merchants can benefit from the same powerful marketing programs that were previously only available to the larger national chain stores.

These powerful programs will help merchants build a larger and more loyal base of customers by:

Identify existing loyal customers

Build sales among existing customers

Help attract and hold new customers

Increase average transaction size and purchase frequency

Enable more efficient cross-promotion of products or services to preferred customers on a “one to one basis.”

Executed transactions then sent from the terminal back to the server where they are added to a database of all transaction data. Merchants can access this data over the internet and use powerful reporting tools to extract and manage their own data. This can be extended to accommodate future enhancements such as yield management and smart marketing programs targeted at specific cardholders or demographic groups. This simple, streamlined process allows merchants to setup and administer their own accounts without requiring customer service support. Cardholders can also access their account data for balance checking, enrollment/update profile, and previous transaction review.

### RELATED APPLICATIONS

| | | |
|---|---|---|
| 5,380,991 | Valencia et al | 1/95 |
| 5,459,306 | Stein et al | 10/95 |
| 5,689,100 | Carrithers, et al. | 11/97 |
| 6,024,288 | Gottlich, et al. | 2/00 |
| 6,119,933 | Wong, et al. | 9/00 |
| 6,119,945 | Muller, et al. | 9/00 |
| 6,336,099 | Barnett, et al. | 1/02 |
| 6,266,647 | Fernandez | 7/01 |
| 6,409,080 | Kawagishi | 6/02 |

### FEDERAL SPONSORED R&D

None.

### FIELD OF THE INVENTION

This invention relates to programmable merchant point of sale (POS) terminals that can be individually configured. Loyalty includes card based programs through which merchants can modify customer behavior by offering incentives. Such loyalty programs promote long term customer/merchant relationship, encourage desired customer activity, and gather strategic marketing and sales customer information. Examples of such loyalty programs include frequent purchase rewards (commonly called a punch card), point accumulation, discount cards, gift cards, and electronic coupons.

### BACKGROUND OF THE INVENTION

POS terminals typically have a card reading device, a numeric keypad, an LCD display, a receipt printer, and a modem. A typical transaction sequence is as follows: the terminal will read a customer card, prompt the terminal operator to enter some information using the keypad, print a receipt of the transaction, and send a summary of the transaction to a central server via modem. Cards can be magnetic stripe, barcode, or smart cards.

The most popular POS terminal applications consist of credit/debit card transactions and gift card transactions. There exist a smaller, yet growing, number of loyalty and frequent shopping applications that have been programmed to run on POS terminals. These loyalty applications are individually created and then programmed and deployed on a per merchant basis. Such single-purpose applications significantly limit any flexibility or merchant level customization. One size is expected to fit all and as a result the application is not optimized for any of the merchants. Further, any significant changes to the application requires a complete reload of the terminal software and in most cases requires a service rep to go out to the merchant's physical location to swap out systems.

### DESCRIPTION OF THE PRIOR ART

U.S. Pat. No. 6,336,099 to Barnett, et al discloses a loyalty system for distributing electronic coupons to customer's home computers. These coupons are printed at home by the customer and then simply presented at retail. As such there is no provision for a programmable POS terminal.

Other related patents such as U.S. Pat. No. 5,459,306 to Stein, U.S. Pat. No. 5,380,991 to Valencia, or U.S. Pat. No. 6,119,933 to Wong address loyalty specifically from the customer's perspective and offer no control or management mechanisms for the merchants.

Much of the other prior art including U.S. Pat. No. 6,024,288 to Gottlich, U.S. Pat. No. 6,119,945 to Muller, and U.S. Pat. No. 6,266,647 to Fernandez, focus on the features of the token such as security and the storage and management of the data elements.

### SUMMARY OF THE INVENTION

It is therefore an object of the present invention to overcome the aforementioned drawbacks and to provide merchants a fully configurable system for retail loyalty programs. Such a system will empower merchants to design and manage their own customized loyalty programs.

A first aspect of the present invention is the capability to dynamically modify the manner in which a POS terminal operates. The described terminal architecture has a single code base that defines a framework in which customized applications can be run. Even though all of the merchants will have the same terminal and installed software framework, they each can be running their own individual customized loyalty promotions. Further, the merchants are empowered with the flexibility to easily alter the contents and operation of their individual loyalty promotions.

A second aspect of the present invention is to define a custom application through an organized set of parameters referred to as an instruction package.

A third aspect of the present invention is to provide a secure means by which the terminal can receive instruction packages and in turn process these to update the POS configuration. This may be via modem, over a network, or by smart card. These updates can be sent according to a schedule or provided on demand every time a transaction is initiated.

A fourth aspect of the present invention is to provide an interface for the merchants to define the characteristics and behavior of their application. This is accomplished through an internet application.

A fifth aspect of the present invention is to provide the reporting tools for merchants to measure the results of their specific programs.

A sixth aspect of the present invention is for cardholders to be able to go to a website and review their status which might include account balances and transaction histories, as well as program updates and new offerings.

These and other aspects of the present invention will become more readily apparent from the attached drawings and detailed description given herinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 illustrates the system components including the POS terminal, offsite central server, and the internet tools.

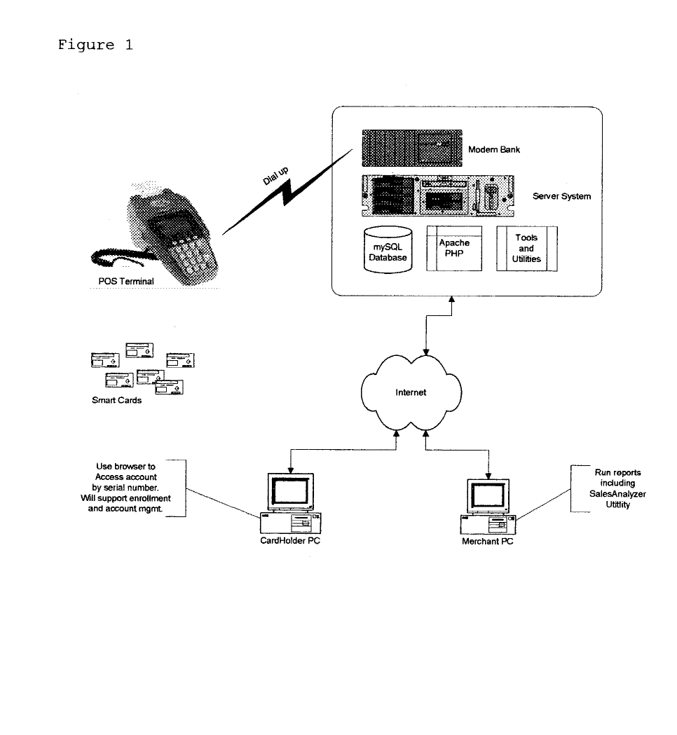

FIG. 2 illustrates the process for creating and managing an instruction package.

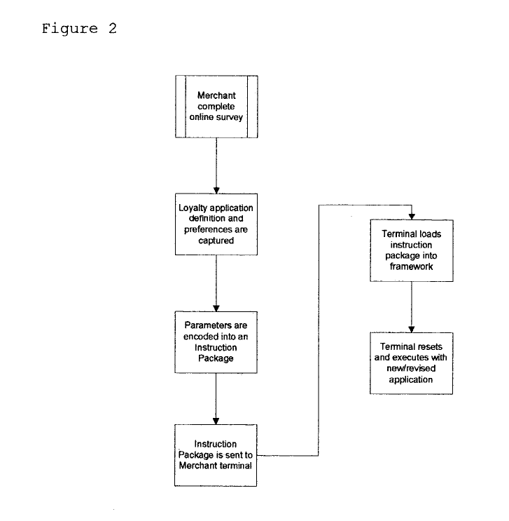

The present invention will become more fully understood from the detailed description given below.

### DETAILED DESCRIPTION OF THE INVENTION

The disclosed invention consists of a configurable POS terminal device and associated method for merchants to customize the operation of the terminal in order to run their own loyalty programs. Loyalty programs are typically structured so that customers of participating merchants earn “points” or credits, which ultimately translate into discounts, rewards or other incentives. However, loyalty programs can be even more sophisticated in their design and implementation in order to target very specific customer behavior. This invention empowers merchants to field these more powerful programs.

The apparatus is a programmable POS terminal which receives operating instructions from the merchant by way of a central server. The POS terminal is initialized with an application framework. This framework is specifically designed to provide basic terminal functions and make available an environment in which customized loyalty programs can be loaded, configured, and executed. The behavior of a specific merchant loyalty program is defined through parameters which are read into this framework.

These parameters are organized into an encoded format called an instruction package. The terminal has a modem or ethernet port which allows it to connect to the central server to receive updated instruction packages. Alternatively, the instruction package can be transferred to the terminal by a specially formatted smart card. In this way the behavior of the POS terminal can be easily customized remotely without altering the underlying compiled code resident in the terminal.

The following summarizes all of the parameters that can be passed as part of the instruction package. This should be robust enough to significantly customize the behavior of the terminal.

| VariableName | Type | Allowable Values | Comment |
|---|---|---|---|
| cfcardlype | 1 byte | 0 = Magstripe | |
| | | 1 = Multiflex | |
| | | 2 = Payflex | |
| | | 3 = MPCOS | |
| | | 4 = Primeflex | |
| | | 5 = T2G | |
| | | 6 = CardLogix | |
| | | 7,8,9 = RFU | |
| cfcardKeyTrans | 8 byte | | Authentication/Transport key |
| cfcardKeyCredit | 8 byte | | Key required for Credit |
| cfcardKeyOther | 8 byte | | Key for future use |
| cfcardKeyDiversifiedFlag | 1 byte | 0 = None | Diversified flag |
| | | 1 = DES with master | |
| | | 2 = DES with Terminal SN | |
| | | 3 = DES with Card SN | |
| | | 4,5,6,7,8,9 = RFU | |
| cfTermID | 4 bytes | Identify terminal | instead of using built in MagIC SN? |
| cfTermType | 1 byte | Identify term Type | 1 = MagIC6000 2 = MagIC9000 3 = Exadigm |
| cfapplServerTrack | 1 byte | 0 = No | Server tracking flag |
| | | 1 = Yes | |
| cfapplBirthdayAnniversary | 1 byte | 0 = No | Special day promotion flag |
| | | 1 = Yes, always dial | |
| | | 2 = Yes, get DOB from chip | |
| | | 3 = Yes, get Anniv from chip | |
| cfapplBirthAnnivDayTolerance | 2 bytes | number of days | |
| | | | Begin Promotion specific parameters |
| cfapp1Type1 | 1 byte | 0 = Empty (app not active) | |
| | | 1 = Volume Points | |
| | | 2 = requency Credits | |
| | | 3 = RFU | |
| | | 4 = Gift Card | |
| | | 5 = % Discount | |
| | | 6 = fixed Discount | |
| | | 7 = Gift with Purchase | |
| | | 8 = Purchase with Purchase | |
| | | 9 = Message only | |
| | | 10 = Invitation only | |
| | | 11 = Limited inventory offer | |
| | | 12,13,14,15 = RFU | |
| cfapplID1 | 4 bytes | Identifies promotion1 | |
| cfapplCurrency1 | 8 bytes | Possible values are “dollars”, | pad with spaces or null terminated? |
| | | “points”, “visits”, “credits” | |
| cfapplRewardAmt1 | 8 bytes | | |
| cfapplSchedule1 | 28 bytes | by encoding time of day on 2 | 06h00h21h00h = 6am to 9pm |
| | | bytes (minutes after | |
| | | midnight) the start and stop | |
| | | time for each of 7 days | |
| | | (Sunday first) can be | |
| | | encoded on 28 bytes) | |
| cfapplBlackout1 | 12 bytes | Six dates (2 bytes each) of | hex example: 010102140704000000 would |
| | | upcoming blackouts | mark new years, valentines, and july4 |
| cfapplInitialVerificationl | 1 byte | 0 = None | |
| | | 1 = cardKeyTrans | |
| | | 4 = cardKeyOther | |
| efapplPointAccumulatorRatio1 | 1 byte | Ratio | div4 points |
| cfapplMaxReload1 | 6 bytes | Dollar amount | If 0 then reloading is not possible |
| cfapplPurseID1 | 1 byte | 1 = Purse1 (demo AF AE) | |
| | | 2 = Purse2 (AF AD) | |
| | | 3 = Purse3 (RFU) | |
| | | 4 = Purse4 (RFU) | |
| cfapplCreditKey1 | 1 byte | 0 = None | |
| | | 1 = CardKeyTrans | |
| | | 2 = UserPIN | |
| | | 3 = CardKeyCredit | |
| | | 5 = PIN + CardKeyCredit | |
| cfapplDebitKey1 | 1 byte | 0 = None | |
| | | 1 = CardKeyTrans | |
| | | 2 = UserPIN | |
| | | 4 = CardKeyOther | |
| | | 5 = PIN + CardKeyOther | |
| cfapp1BalanceKey1 | 1 byte | 0 = None | |
| | | 1 = CardKeyTrans | |
| | | 2 = UserPIN | |
| | | 4 = CardKeyOther | |
| cfapplRFU1 | 16 bytes | | |
| cfapplType2 | 1 byte | | |
| cfapplID2 | 4 bytes | | |
| cfapplCurrency2 | 8 bytes | | |
| cfapplRewardAmt2 | 8 bytes | | |
| cfapplSchedule2 | 28 bytes | | |
| cfapplBlackout2 | 12 bytes | | |
| cfapplInitialVerification2 | 1 byte | | |
| cfapplPointAccumulatorRatio2 | 1 byte | | |
| cfapplMaxReload2 | | | |
| cfapplPurseID2 | 1 byte | | |
| cfapplCreditKey2 | 1 byte | | |
| cfapplDebitKey2 | 1 byte | | |
| cfapplBalanceKey2 | 1 byte | | |
| cfapplRFU2 | 16 bytes | | |
| cfdispGreeting1 | 20 bytes | | null terminated |
| cfdispGreeting2 | 20 bytes | | |
| cfcommPrimaryNum | 10 bytes | 10 digit phone # | Primary phone number |
| cfcommSecondNum | 10 bytes | 10 digit phone # | |
| cfcommTransmit | 1 byte | 1 = Every transaction | |
| | | 2 = Redemption only | |
| | | 3 = Batch at night | |
| | | 4 = Special conditions | |
| cfcommBatchTime | 4 bytes | timefield (militaxy) | Time of day to dial in. Only relevant if |
| | | | CommTransmit 3. |
| cfcommDialonSensitive | 1 byte | 0 = No | Dial in as an extra check to credit dollars or |
| | | 1 = Yes | redeem loyalty points. |
| cfrcptHeader1 | 20 byte | null terminated | |
| cftcptHeader2 | 20 bytes | | |
| cfrcptFooter1 | 20 bytes | | |
| cfrcptFooter2 | 20 bytes | | |
| cfrcptFont | 1 byte | 1 = Standard font | |
| | | 2 = Next size up | |
| | | 3 = Largest font | |
| cfrcptFlags | 1 byte | 00000001 = Time/date | Flags to effect the look of printed receipt |
| | | 00000010 = Print Server ID | |
| | | 00000100 = Left Justify | |
| | | 00001000 = 2 Receipts | |
| | | 00010000 = RFU | |
| | | 00100000 = RFU | |
| | | 01000000 = RFU | |
| | | 10000000 = RFU | |
| cfRFU | 31 bytes | | |
| cfpckgDigitalSignature | 8 bytes | | Signed hash of entire configuration file to |
| | | | protect data integrity |
| Total → | 400 | | |

An internet-based application enables the merchant to define their loyalty application by completing a survey to identify the specific parameters of their own unique loyalty promotions. This application presents a series of menus to capture the preference elements of a merchant's loyalty program. Configurable preference elements include all of the possible items that comprise the operation of a loyalty program. Examples of specific preference elements are:

promotions/discounts and other rules of use

types and parameters of promotions

settings for system options

menu prompts

displayed and printed messages such as receipt wording

Once captured, these preference elements are then compiled into an instruction package encoded in the format described previously. This instruction package is sent from the central server to the in-store terminal over a standard telephone line or internet connection. The merchant's POS terminal interprets this instruction package and then adjusts its functionality accordingly. Most importantly these changes can be relayed to the actual terminal on demand so that the loyalty program is truly “on the fly” configurable.

In addition to program configuration and setup, this same internet application provides the merchant an important set of tools for transaction management and data analysis. Since all transactions are reported back to the central server, there are many powerful reports that the merchant can run. Additionally, cardholders can access data resident on the central server in order to check account balances. All of the data is partitioned in a secure manner so that data can only be accessed/modfied by the appropriate person with the correct credentials.

1) A method for merchants to create and customize their own loyalty program implementations comprising the following steps:
capture merchant's preference elements for their promotions and loyalty programs.
collect and store these preference elements in a central server.
translate preference elements into an organized set of parameters.
encode the parameters into a format (instruction package) suitable for exchange with specific point of sale (POS) terminals.
distribute the instruction packages to their respective POS terminals.
receipt and interpretation of the instruction package by the POS terminal.
update POS terminal functionality according to the parameters as relayed by the instruction package.

2) Method of claim 1 wherein the preference elements are captured using a survey tool that the merchant fills out over the internet.

3) Method of claim 1 wherein the preference elements are such things as: menu prompts, receipt wording, valid tokens, start/end/blackout dates, promotions/discounts and other rules of use.

4) Method of claim 1 wherein the instruction package can be encoded and distributed to the Merchant Loyalty POS terminal in a secure fashion. The transmission is encrypted for privacy and authenticated to prevent impersonation by a rogue terminal.

5) Method of claim 1 wherein the entire application refresh process can happen on demand each time that a POS terminal initiates a transaction.

6) An apparatus for Merchant Loyalty comprising:
a static memory for storing an application framework which comprises the generic elements and business rules for promotions and loyalty program.
an input buffer in which to receive the instruction package from an external source.
a dynamic memory for storing the configuration parameters as extracted from the instruction package.
a means to process and execute the application framework based upon the configuration parameters.
a mechanism for reading cards and tokens.
an output buffer to transmit completed transaction data back to a central server.

7) Apparatus of claim 6 wherein the instruction package is received from a central server by telephone line.

8) Apparatus of claim 6 wherein the instruction package is transferred to the POS by a specially formatted smart card.

9) Apparatus of claim 6 wherein the instruction package is transferred to the POS in real time by an internet connection.

10) Apparatus of claim 6 wherein the said Merchant Loyalty POS Terminal can be configured to interoperate with a plurality of customer cards including contact smart cards, contactless cards, barcode, and magnetic stripe.

11) Apparatus of claim 6 wherein the said Merchant Loyalty POS Terminal can be configured to interoperate with a plurality of customer tokens such as keytags and fobs, RFID, 3^{rd} party issued credentials such as drivers licenses or credit cards.

12) Apparatus of claim 6 wherein the said Merchant Loyalty POS Terminal can also support 3^{rd} party applications such as payment.

13) Method for storing and managing the resulting transaction data so that merchants can obtain specific results over the internet for their individual merchant application and cardholders can access their account data.

14) Method of claim 13 including reporting tools and other metrics for the merchant to determine program effectiveness.

15) Method of claim 13 such that cardholders need only enter their card number into a website to access their account.
